(19) United States
(12) Patent Application Publication
(10) Pub. No.: US 2016/0205999 A1
(43) Pub. Date: Jul. 21, 2016

(54) ELECTRONIC CIGARETTE

(71) Applicant: KIMREE HI-TECH INC., Tortola (VG)

(72) Inventor: QIUMING LIU, Huizhou City, Guangdong Province (CN)

(21) Appl. No.: 14/383,957

(22) PCT Filed: Mar. 29, 2013
(86) PCT No.: PCT/CN2013/073486

§ 371 Date: Sep. 9, 2014

(51) Int. Cl. A24F 47/00; H05B 3/00; H05B 1/02

(52) U.S. Cl. CPC A24F 47/008; H05B 1/0244; H05B 3/0014

(57) ABSTRACT

The present invention provides an electronic cigarette including a main rod. The main rod is a hollow barrel structure with an open end. The main rod axially defines a suction hole in a middle of a bottom wall and passing through the bottom wall which is far away from the open end so as to form a nozzle end for smoking the electronic cigarette. The main rod is integrally molded. The electronic cigarette of the present invention can effectively avoid a nozzle cap off problem which always happened in traditional disposable electronic cigarette by disposing the suction hole at one end of the main rod.

### FIELD OF THE INVENTION

The present invention relates to an electronic cigarette, especially relates to a disposable electronic cigarette including a nozzle cap integrated with a main rod.

### BACKGROUND OF THE INVENTION

The existing disposable electronic cigarette outer case is generally composed of three components: a main rod, a nozzle cap and a lamp cap. The nozzle cap and the lamp cap are disposed at the two opposite ends of the main rod respectively. As the main rod and the nozzle cap of the traditional disposable electronic cigarette are disposed as two separate parts, and they are usually fixed by interference connection, it makes not only production and assembly of trouble, but also very easy to fall off when using or even may be inhaled to mouth by mistake.

### SUMMARY OF THE INVENTION

The problem of the present invention to be solved is to provide an electronic cigarette with a nozzle end with stable structure, which can effectively avoid a nozzle cap off problem which always happened to the traditional disposable electronic cigarette.

To achieve the above-mentioned object, the present invention provides an electronic cigarette including a main rod. The main rod is a hollow barrel structure with an open end. The main rod axially defines a suction hole in a middle of a bottom wall and passing through the bottom wall which is far away from the open end so as to form a nozzle end for smoking the electronic cigarette. The main rod is integrally molded.

In a further embodiment, an inner wall of the suction hole axially extends toward the internal of the main rod to form an air guide post for guiding smoking flow.

In a further embodiment, the electronic cigarette further comprises an atomization device disposed inside the main rod to atomize liquid smoke, and a battery electrically connected with the atomization device for supplying power to the atomization device.

In a further embodiment, the atomization device comprises a liquid storage element for storing liquid smoke, an atomizer abutted with the liquid storage element for atomizing liquid smoke, and an atomization seat and an atomization cover which are separately disposed at opposite ends of the liquid storage element for sealing the liquid storage element.

In a further embodiment, the atomization device is disposed at one side in the main rod and adjacent to the nozzle end, an inner wall of the nozzle end of the main rod radially extends to form a boss for abutting to the atomization cover.

In a further embodiment, the liquid storage element is fixed between the atomization seat and the atomization cover by a support.

In a further embodiment, the support is a hollow tube structure and forms an atomization chamber in the middle thereof for guiding airflow and accommodating the atomizer.

In a further embodiment, the atomizer includes an atomization rod and electric wire wrapping on the atomization rod, the atomization rod is radially disposed and fixed inside the support and two ends of the atomization rod and abuts to the liquid storage element respectively, a sidewall of the support radially defines a latch opening for the atomization rod passing through.

In a further embodiment, the battery is disposed at one side of the atomization seat away from the liquid storage element, one sidewall of the atomization seat defines a first threading hole and a second threading hole which are used for two ends of the electric wire passing through and connecting to positive and negative of the battery respectively.

In a further embodiment, the atomization seat and the atomization cover are engaged with each other by interference fit, and middles of the atomization seat and the atomization cover respectively define a first vent and a second vent correspondingly for communicating to the atomizing chamber to guide airflow.

In a further embodiment, the electronic cigarette further comprises an atomization control unit connected with the battery to control the atomization device powered on or off, the atomization control unit is set between the atomization device and the battery, or set on one side of the battery away from the atomization device.

In a further embodiment, the atomization control unit includes an atomization control circuit and an atomization control switch connected to the atomization control circuit; the atomization control switch is a capacitive sensor switch, or an airflow sensor switch, or a key switch; the atomization control circuit is integrated within the atomization control switch, or the atomization control unit further includes an atomization control circuit board connected to the battery and the atomization control switch respectively, the atomization control circuit is integrated in the atomization control circuit board.

In a further embodiment, one side of the battery away from the atomization device disposes a light emitting device to simulate cigarette burning, the light emitting device includes a light-emitting unit connected with the battery, the open end of the main rod disposes a cover to seal the main rod, the whole or at least one end face of the cover is disposed transparent or translucent to let the light emitting unit to emit light out.

In a further embodiment, the cover and the main rod are engaged with each other by interference fit.

In a further embodiment, an outer surface of the main rod has a sticker.

The advantage of the present invention are: By setting the integration of the main rod, and defining suction holes on the bottom wall of one end of the main rod, it achieves an effective solution to resolve smoking nozzle cap off problems when using traditional disposable electronic cigarette, simple structure, and easier to use.

Embodiments of the present invention will be further described in detail in the following drawings.

### BRIEF DESCRIPTION OF THE DRAWINGS

FIG. 1 is a schematic structure diagram of an electronic cigarette embodiment of the present invention.

FIG. 2 is a schematic cross-sectional structure diagram of an electronic cigarette embodiment of the present invention.

FIG. 3 is an exploded view of an electronic cigarette embodiment of the present invention.

FIG. 4 is a cutaway view of the main rod of an electronic cigarette embodiment of the present invention.

### DETAILED DESCRIPTION OF THE INVENTION

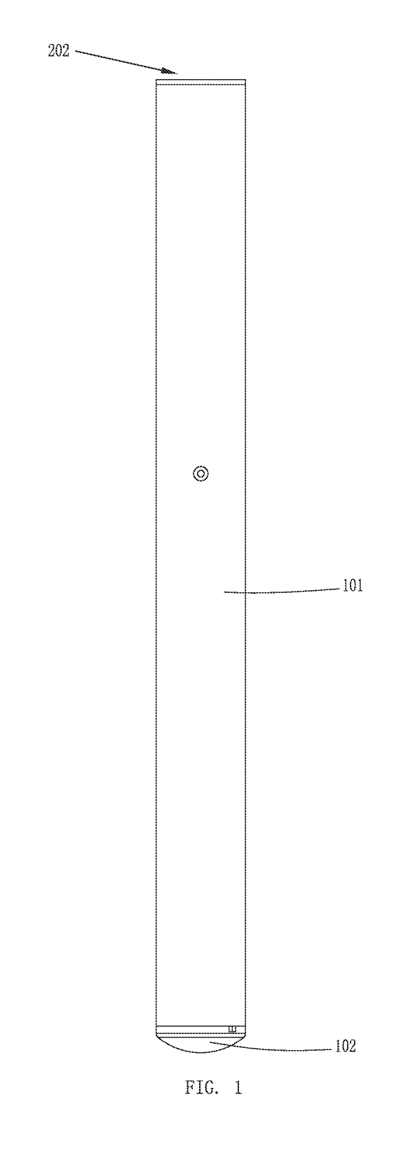

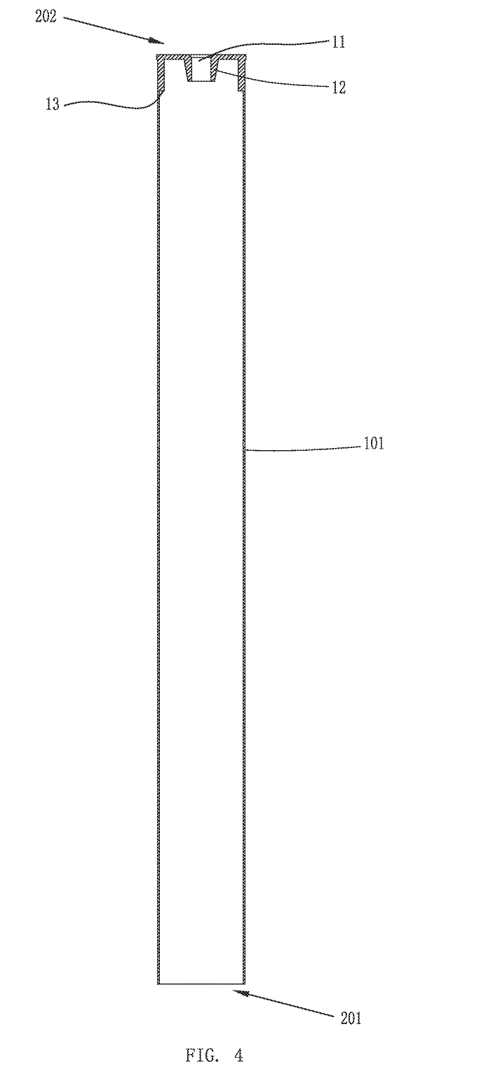

Referring to the FIGS. 1-4, an embodiment of the present invention provides a disposable electronic cigarette, including a main rod 101. Referring to FIG. 4, the main rod 101 is a hollow barrel structure with an open end. A middle of a bottom wall of the main rod 101 away from the open end axially defines a suction hole 11 passing through the bottom wall so as to form a nozzle end 202 for smoking the electronic cigarette. An inner wall of the suction hole 11 axially extends toward the internal of the main rod 101 to form an air guide post 12 for guiding smoking flow.

In the embodiment of the present invention, the main rod 101 can be made of metal, plastic, paper, wood and other materials, and is preferably set to like a true cigarette with circular cross-section shape of a barrel structure to strengthen the simulation of the electronic cigarette. Of course, the main rod 101 may also be disposed as polygonal in cross-section or other combinations of the barrel-shaped structure depending on design requirements to enrich the exterior styles of the electronic cigarette.

Referring to the FIGS. 1-3, the open end 201 of the main rod has a cover 102, and the cover 102 is fixed on the end of the main rod 101 to coordinate with the main rod 101 to seal the electronic cigarette.

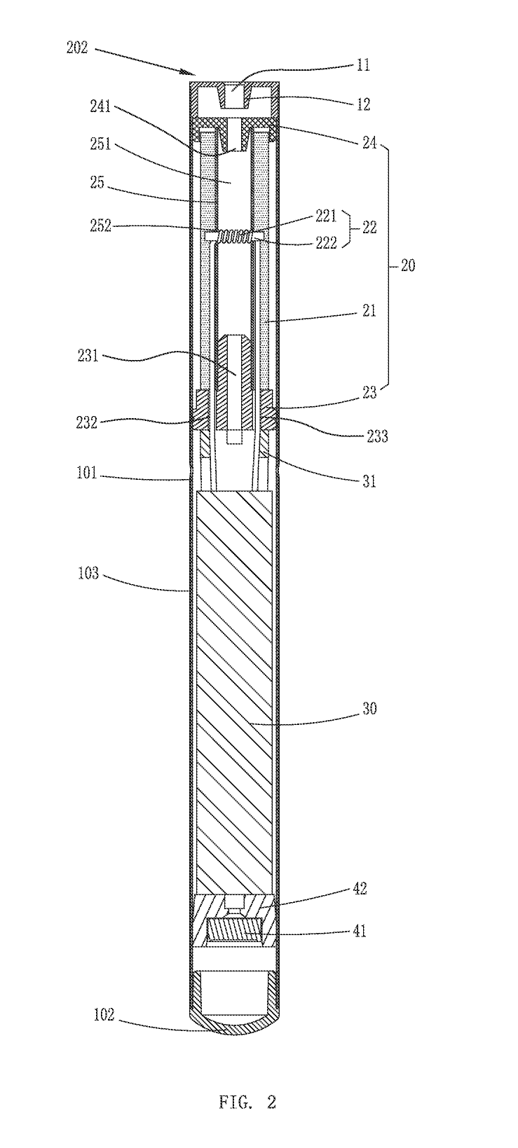

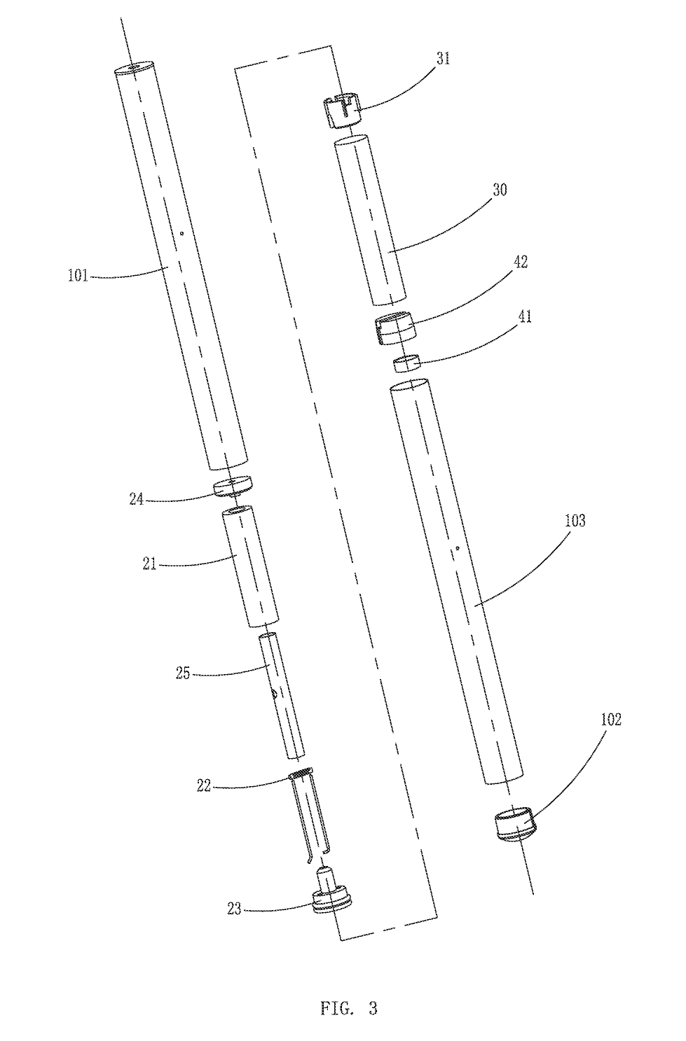

Referring to FIG. 2 to FIG. 3, the main rod 101 disposes an atomization device 20 and a battery 30 inside thereof. The atomization device 20 is used for atomizing liquid into smoke for users smoking, and the battery 30 is electrically connected with the atomization device 20 to provide power for the atomization device 20.

The atomization device 20 includes a liquid storage element 21, an atomizer 22, an atomization seat 23 and an atomization cover 24.

The atomization device 20 is disposed adjacent to the nozzle end 202 of the main rod 101. The inner wall of the nozzle end 202 of the main rod 101 radially extends to form a boss 13 for abutting the atomization cover 24.

The liquid storage element 21 can absorb and store liquid and is used to absorb and store liquid smoke to facilitate the liquid smoke atomization by the atomizer 22. In the embodiment, the liquid storage element 21 can be made from materials capable of absorbing and storing liquid such as glass fiber, nonwoven fabric, wood pulp fiber, chemical fiber, polyvinyl alcohol, high-temperature resistance cotton, chemical fiber cotton, mixed cotton, absorbent cotton, nickel foam and other materials.

In the embodiment, the liquid storage element 21 is disposed as a hollow tube structure to match with the main rod 101, and coaxially disposed with the main rod 101.

Referring to the FIG. 2, in the embodiment, the liquid storage element 21 is fixed between the atomization seat 23 and the atomization cover 24 by a support tube 25. The support tube 25 forms an atomization chamber 251 for guiding airflow and accommodating the atomizer 22 in the center thereof.

The atomizer 22 is used to atomize the liquid smoke to smoke. In the embodiment, the atomizer 22 is composed of an electric wire 221 and an atomization rod 222. The electric wire 221 wraps on the atomization rod 222, and the atomization rod 222 is supported and fixed inside the liquid storage element 21 to absorb liquid smoke from the liquid storage element 21 to supply to the electric wire 221 for heating and atomizing the liquid smoke. In the embodiment, the atomization rod 222 is disposed as cylindrical and it can be made of fiberglass of other high temperature resistance fiber materials capable of absorbing liquid.

In the embodiment, the atomization rod 222 is radially disposed inside the support tube 25. The sidewall of the support tube 25 defines a latch opening 252 radially running through the sidewall. Two ends of the atomization rod 222 extend outside from the support tube 25 through the latch opening 252 and abut to the inner wall of the liquid storage element 21 to absorb the liquid smoke from the liquid storage element 21 for heating and atomizing by the electric wire 221. Specifically, to avoid the atomization rod 222 axially moving inside the support tube 25, a positioning tube can be disposed at the external of the support tube 25 and at the top or below of the atomization rod 222.

Due to high temperature when the electric wire 221 heating and atomizing liquid smoke, in order to enhance the life and heat resistance of the liquid storage element 21, in the embodiment, a heat insulating component made of high temperature resistance and capable of liquid absorbing materials can be set between the liquid storage element 21 and the support tube 25 to enhance the protection of the liquid storage element 21.

In the embodiment, both the atomization seat 23 and the atomization cover 24 are made of rubber materials such as silicone capable of elastic deforming, and the outer contour of the atomization seat 23 and the atomization cover 24 are adapted with the inner contour of the main rod 101 and preferably engage with the main rod 101 by interference fit. Both the atomization seat 23 and the atomization cover 24 use outer wall tensioner to be fixed inside the main rod 101 to sealingly fix the liquid storage element 21 in the main rod 101. Referring to the FIG. 2, in the central of the atomization seat 23 and the atomization cover 24 defines a first vent 231 and a second vent 241 correspondingly for communicating with the atomizing chamber 251 to guide airflow.

Refer to FIG. 2, in the embodiment, the battery 30 is disposed at one side of the atomization seat 23 away from the liquid storage element 21, and is fixed inside the main rod 101 by a support 31. The sidewall of the atomization seat 23 defines a first threading hole 232 and the second threading hole 233 which are used for the two ends of the electric wire 221 passing through. The two ends of the electric wire 221 pass through the first threading hole 232 and the second threading hole 233 respectively and then electrically connected with the battery 30.

Referring to the FIG. 2 and FIG. 3, the main rod 101 also includes an atomization control unit. The atomization control unit is electrically connected with the battery 30 and the atomization device 20 to control the atomization device 20 powered on or off. The atomization control unit is disposed between the atomization device 20 and the battery 30, or disposed on one side of the battery 30 away from the atomization device 20.

In the embodiment, the atomization control unit is preferably disposed on the side of the battery 30 away from the atomization device 20. The atomization control unit includes an atomization control circuit and an atomization control switch connecting with the atomization control circuit.

In the embodiment, the atomization control switch is preferably disposed as a sensor switch 41, and the sensor switch 41 is fixed in the main rod 101 by a switch holder 42. Specifically in the embodiment, the sensor switch 41 is a capacitive sensor switch. When users using the electronic cigarette smoking, the capacitive sensor switch sensors the capacitance change after inhalation flow then control the atomization control circuit to supply power to make the electronic cigarette going to work. As an embodiment, the sensor switch 41 may also be disposed as airflow sensor switch, it means that when users inhaling by the nozzle end of the main rod 101, a chamber of the electronic cigarette produces negative pressure to make the airflow sensor switch generate pulse signals to control the atomization control circuit to supply power.

Since the manufacturing of the sensor switch 41 is in precision, and generally disposes a specialized controller inside. In the embodiment, the atomization control circuit can be directly integrated on the controller in the sensor switch 41. As an embodiment, the atomization control circuit can also be integrated on an atomization control circuit board which is disposed independently out of the sensor switch 41 and electrically connected with the sensor switch 41 and the battery 30 respectively.

As an embodiment, the atomization control switch can also be disposed as traditional key switch. The key switch is electrically connected with the battery 30 by a key switch board to operate the atomization control circuit via the key controlling, and then achieves the circuit of the atomization device 20 connected and disconnected.

In the embodiment, the open end 201 of the main rod 101 disposes a light emitting device. The light emitting device is used as work light for the electronic cigarette, and includes a light-emitting unit which is electrically connected with the battery 30. In the embodiment, the light-emitting unit is disposed as a red light emitting lamp. When users smoke the electronic cigarette, red aperture similar to cigarette combustion appears at one end away from the nozzle end of the electronic cigarette to improve the reality of the visual look and feel for smokers. In order to let the light from light emitting unit send out, the whole or at least one end face of the cover 102 is disposed transparent or translucent. In the embodiment, the cover 102 is wholly made of transparent plastic materials.

To further improve the simulation of the electronic cigarette 100 and strengthen hand feeling, the outer surface of the main rod 101 disposes a sticker 103. A side surface of the sticker 103 facing outside can be printed patterns same or similar to real appearance of cigarettes, and the other side surface of the sticker 103 sticking with the main rod 101 can dispose any paste agent which can stick the sticker 103 with the main rod 101.

It is understood that the electronic cigarette of the present inventions is not limited to the embodiments shown in the FIG. 1 to FIG. 4, various technical features from embodiments may be combined to form new embodiments.

Embodiments of the present invention is shown and described in the above-mentioned. Various improvement and modifications can be made to the embodiments by those skilled in the art without departing from the true spirit and scope of the disclosure. The scope of the present invention is defined by the appended claims and equivalents thereof.

1. An electronic cigarette, comprising:
a main rod, the main rod configured for being a hollow barrel structure with an open end, a middle of a bottom wall of the main rod away from the open end axially defining a suction hole passing through the bottom wall to form a nozzle end for smoking the electronic cigarette, the main rod being integrally molded.

2. According to the electronic cigarette in claim 1, wherein an inner wall of the suction hole axially extends toward the internal of the main rod to form an air guide post for guiding smoking flow.

3. According to the electronic cigarette in claim 1, wherein the electronic cigarette further comprises an atomization device disposed inside the main rod to atomize liquid smoke, and a battery electrically connected with the atomization device for supplying power to the atomization device.

4. According to the electronic cigarette in claim 3, wherein the atomization device comprises a liquid storage element for storing liquid smoke, an atomizer abutted with the liquid storage element for atomizing liquid smoke, and an atomization seat and an atomization cover which are separately disposed at opposite ends of the liquid storage element for sealing the liquid storage element.

5. According to the electronic cigarette in claim 4, wherein the atomization device is disposed at one side in the main rod and adjacent to the nozzle end, an inner wall of the nozzle end of the main rod radially extends to form a boss for abutting to the atomization cover.

6. According to the electronic cigarette in claim 4, wherein the liquid storage element is fixed between the atomization seat and the atomization cover by a support.

7. According to the electronic cigarette in claim 6, wherein the support is a hollow tube structure and forms an atomization chamber in the middle thereof for guiding airflow and accommodating the atomizer.

8. According to the electronic cigarette in claim 7, wherein the atomizer includes an atomization rod and electric wire wrapping on the atomization rod, the atomization rod is radially disposed and fixed inside the support and two ends of the atomization rod and abuts to the liquid storage element respectively, a sidewall of the support radially defines a latch opening for the atomization rod passing through.

9. According to the electronic cigarette in claim 8, wherein the battery is disposed at one side of the atomization seat away from the liquid storage element, one sidewall of the atomization seat defines a first threading hole and a second threading hole which are used for two ends of the electric wire passing through and connecting to positive and negative of the battery respectively.

10. According to the electronic cigarette in claim 7, wherein the atomization seat and the atomization cover are engaged with each other by interference fit, and middles of the atomization seat and the atomization cover respectively define a first vent and a second vent correspondingly for communicating to the atomizing chamber to guide airflow.

11. According to the electronic cigarette in claim 3, wherein the electronic cigarette further comprises an atomization control unit connected with the battery to control the atomization device powered on or off, the atomization control unit is set between the atomization device and the battery, or set on one side of the battery away from the atomization device.

12. According to the electronic cigarette in claim 11, wherein the atomization control unit includes an atomization control circuit and an atomization control switch connected to the atomization control circuit; the atomization control switch is a capacitive sensor switch, or an airflow sensor switch, or a key switch; the atomization control circuit is integrated within the atomization control switch, or the atomization control unit further includes an atomization control circuit board connected to the battery and the atomization control switch respectively, the atomization control circuit is integrated in the atomization control circuit board.

13. According to the electronic cigarette in claim 3, wherein one side of the battery away from the atomization device disposes a light emitting device to simulate cigarette burning, the light emitting device includes a light-emitting unit connected with the battery, the open end of the main rod disposes a cover to seal the main rod, the whole or at least one end face of the cover is disposed transparent or translucent to let the light emitting unit to emit light out.

14. According to the electronic cigarette in claim 1, wherein the cover and the main rod are engaged with each other by interference fit.

15. According to the electronic cigarette in claim 1, wherein an outer surface of the main rod has a sticker.

16. According to the electronic cigarette in claim 2, wherein an outer surface of the main rod has a sticker.

17. According to the electronic cigarette in claim 3, wherein an outer surface of the main rod has a sticker.

18. According to the electronic cigarette in claim 4, wherein an outer surface of the main rod has a sticker.

19. According to the electronic cigarette in claim 5, wherein an outer surface of the main rod has a sticker.

20. According to the electronic cigarette in claim 6, wherein an outer surface of the main rod has a sticker.
